(19) United States
(12) Patent Application Publication
(10) Pub. No.: US 2017/0039812 A1
(43) Pub. Date: Feb. 9, 2017

(54) Apparatus and Method of Blackjack Game with Dealer-Card Bonus Trigger

(71) Applicant: Bally Gaming, Inc., Las Vegas, NV (US)

(72) Inventors: Gabriel A. Baron, Henderson, NV (US); Kellen C. Roberts, Las Vegas, NV (US); Christopher D. Wester, Henderson, NV (US); Jack F. Chesworth, Hurlstone Park (AU); Richard M. Milosevich, Las Vegas, NV (US); Christine M. Bordeaux, Henderson, NV (US); Dave Reyes, Las Vegas, NV (US)

(21) Appl. No.: 14/817,621

(22) Filed: Aug. 4, 2015

(51) Int. Cl. G07F 17/32

(52) U.S. Cl. CPC G07F 17/3293; G07F 17/3258

(57) ABSTRACT

An electronically administered card game with a multi-tiered bonus game is disclosed. A wager is placed to play a blackjack base game. An optional side bet provides eligibility to players for a bonus game triggered when initial dealer cards are a colored pair. The bonus game occurs after the base game play is resolved. The rank of the initial dealer cards determines a bonus level for the bonus game and a number of indicia for corresponding multiplier and award pick fields. Based upon player indicia selection, a multiplier value for the bonus game is determined in addition to an award amount using a pyramid-pick field of award indicia descending in number in various tiers. Each tier contains indicia specifying a specific award amount and a single indicium enabling selection from a next-higher tier, if available. The bonus game award is determined by adjusting a selected award amount using the multiplier value or awarding a progressive jackpot at the highest bonus level.

### COPYRIGHT

A portion of the disclosure of this patent document contains material that is subject to copyright protection. The copyright owner has no objection to the facsimile reproduction by anyone of the patent disclosure, as it appears in the United States Patent and Trademark Office patent files or records, but otherwise reserves all copyright rights whatsoever.

### TECHNICAL FIELD

This disclosure relates generally to methods of administering wagering games for casinos and other gaming establishments, and related systems and apparatuses. More specifically, the disclosure teaches an implementation of card games suitable for presentation on an automated gaming platform such as a multi-player gaming system or a standalone gaming machine. The disclosed embodiments further relate to base wagering games having designated events that trigger a bonus game and to the bonus games triggered by the designated events.

### BACKGROUND

Gaming machines, such as slot machines, video poker machines, electronic table game systems, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### BRIEF SUMMARY

According to one aspect of the present invention, a gaming system comprises a display device including a community display and a plurality of player stations with each player stations having a player display and a player input device. Each player input device may be configured to detect a physical item associated with a monetary value, the monetary value establishing a credit balance. The gaming system further includes at least one processor for receiving inputs from the plurality of player displays and determining game results. The processor(s) is configured to receive one or more inputs that are indicative of a base-game wager for a base blackjack game. Further, the processor(s) may receive an optional bonus wager for a multi-tiered bonus game. Credit amounts corresponding to the base-game wager and the optional bonus-game wager are deducted from the respective credit balance established for each active player. The processor(s) is further configured to direct one or more player displays of the plurality of player stations and the community display device to display the base blackjack game by dealing two initial cards for each active player hand and two initial cards for the dealer hand. The processor(s) is configured to resolve the base blackjack game for each active player against the dealer hand in accordance with traditional blackjack gameplay, and to determine a corresponding base game award amount for each active player.

In response to the two initial cards of the dealer hand having the same rank and the same color, and the at least one optional bonus wager being received from a first active player, the processor(s) may trigger and conduct the bonus game by directing the player display at the player station of the first active player and the community display to display a plurality of selectable current-tier indicia and a plurality of selectable next-tier indicia. The number of current-tier indicia may be greater than the number of next-tier indicia, and each of the current-tier indicia corresponds to a bonus outcome determined, at least in part, by a random number generator. The processor(s) is further configured to receive, from the player display at the player station of the first active player, an input indicative of a selected current-tier indicia. In response to the selected current-tier indicia corresponding to a tier-advancement bonus outcome, the processor(s) may designate the next-tier indicia available for selection. In response to the selected current-tier indicia corresponding to a bonus outcome indicating an award amount, the processor(s) may determine a corresponding bonus game award amount and grant a total award amount corresponding to the base game award amount and the bonus game award amount.

According to another aspect of the present invention, a multi-player gaming system comprises at least one display device including a community display and a plurality of player stations, and each player station has a player display and a player input device. Also, each player input device is configured to detect a physical item associated with a monetary value, the monetary value establishing a credit balance. The gaming system further includes at least one processor for receiving inputs from the plurality of player stations and determining game results. The processor(s) may be configured to receive, via at least one player station, one or more inputs from active players that are indicative of a base-game wager for a base blackjack game and at least one optional bonus wager for a multi-tiered bonus game. Credit amounts corresponding to the base-game wager and the optional bonus-game wager may be deducted from the respective credit balance established for each active player. The processor(s) is further configured to direct one or more player displays of the plurality of player displays and the community display to display the base blackjack game by displaying two initial cards for each active player hand and two initial cards for the dealer hand. The processor(s) resolve the base blackjack game for each active player against the dealer hand in accordance with traditional blackjack gameplay, and determine a corresponding base game award amount for each active player. In response to the two initial cards of the dealer hand having the same rank and the same color, and the at least one optional bonus wager being received from a first active player, the processor(s) may trigger and conduct the bonus game at a bonus level corresponding to the rank of the two initial cards of the dealer hand.

The bonus game may be conducted by directing the player display at the player station of the first active player and the community display to display a plurality of selectable current-tier indicia and a plurality of selectable next-tier indicia. The number of current-tier indicia may be greater than the number of next-tier indicia and may be based on the bonus level. Each of the current-tier indicia may correspond to a bonus outcome that is determined, at least in part, by a random number generator. The processor(s) may receive an input indicative of a selected current-tier indicia from the player station of the first active player. In response to the selected current-tier indicia corresponding to a tier-advancement bonus outcome, the processor(s) may designate the next-tier indicia available for selection. In response to the selected current-tier indicia corresponding to a bonus outcome indicating an award amount, the processors(s) may determine a corresponding bonus game award amount. The processors(s) may further grant a total award amount corresponding to the base game award amount and the bonus game award amount.

According to still another aspect of the present invention, a method of administering a wagering game on a multi-player gaming system is disclosed. The multi-player gaming system may include at least one display device including a community display and a plurality of player stations, and at least one processor. Each player station may have a player display and a player input device, with the player input device being configured to detect a physical item associated with a monetary value that establishes a credit balance. The processor(s) may be configured for receiving inputs from the plurality of player stations and determining game results. The method comprises receiving, by at least one player station, one or more inputs from active players indicative of a base-game wager for a base blackjack game and at least one optional bonus wager for a multi-tiered bonus game. Credit amounts corresponding to the base-game wager and the at least one optional bonus-game wager may be deducted from the respective credit balance established for each active player. The method further includes directing, by the processor(s), player displays at one or more of the plurality of player displays and the community display to display the base blackjack game by displaying two initial cards for each active player hand and two initial cards for the dealer hand. The method also includes resolving, by the processor(s), the base blackjack game for each active player against the dealer hand in accordance with traditional blackjack gameplay, and determining a base game award amount. In response to the two initial cards of the dealer hand having the same rank and the same color, and receiving at least one optional bonus wager from a first active player. The method further includes triggering and conducting the bonus game at a bonus level corresponding to the rank of the two initial cards for the dealer hand.

The method conducts the bonus game by directing, by the processor(s), the player display at the player station of the first active player and the community display to display a plurality of selectable current-tier indicia and a plurality of selectable next-tier indicia. The number of current-tier indicia may be greater than the number of next-tier indicia and may be based on the bonus level, and each of the current-tier indicia may correspond to a bonus outcome that is determined, at least in part, by a random number generator. The method includes receiving, from the player station of the first active player, an input from the active player indicative of a selected current-tier indicia. In response to the selected current-tier indicia corresponding to a tier-advancement bonus outcome, the method may designate the next-tier indicia available for selection. Further, in response to the selected current-tier indicia corresponding to a bonus outcome indicating an award amount, the method may determine, by the processor(s), a corresponding bonus game award amount. The method further includes granting, by the processor(s), a total award amount corresponding to the base game award amount and the bonus game award amount.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3A is a perspective view of a multi-player gaming system according to an embodiment of the present invention.

FIG. 3B is a functional schematic view of a multi-player gaming system according to an embodiment of the present invention.

FIG. 3C is a view of an exemplary game play layout according to an embodiment of the present invention.

FIG. 4A is a flowchart of an algorithm that corresponds to instructions executed by one or more processors according to an embodiment of the present invention.

FIG. 4B is a flowchart of an algorithm that corresponds to instructions executed by one or more processors according to an embodiment of the present invention.

FIGS. 5A and 5B are images of exemplary screens of a wagering game displayed on a gaming machine, gaming system, or other medium, according to an embodiment of the present invention.

FIGS. 6A and 6B are images of exemplary bonus-game screens of a wagering game displayed on a gaming machine, gaming system, or other medium, according to an embodiment of the present invention.

### DETAILED DESCRIPTION

While this invention is susceptible of embodiments in many different forms, there is shown in the drawings and will herein be described in detail embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like, include games in which a player places at risk a sum of money or other representation of value, whether or not redeemable for cash, on an event with an uncertain outcome including, without limitation, those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking website, other websites, across computer networks, or applications on mobile devices (e.g., phones, tablets, etc.). When provided in a social or casual game format, the wagering game may closely resemble a traditional casino game, or it may take another form that more closely resembles other types of social/casual games.

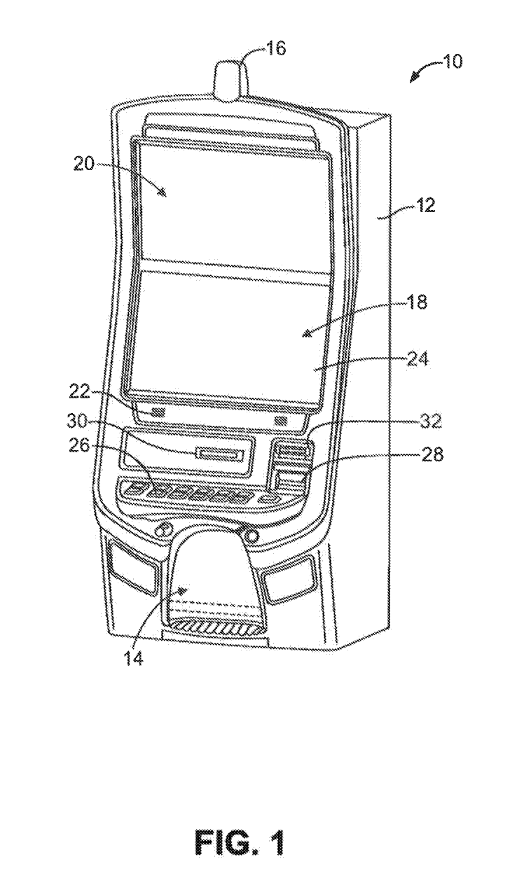

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. In further aspects, the gaming machine 10 is an electronic table game system. The gaming machine 10 may take any suitable form, such as floor-standing models as shown, multi-player gaming systems, hand-held mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. No. 6,517,433, U.S. Pat. No. 8,057,303, and U.S. Pat. No. 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays 18, 20 variously display information associated with wagering games, non-wagering games, community games, progressives, advertisements, services, premium entertainment, text messaging, emails, alerts, announcements, broadcast information, subscription information, etc., appropriate to the particular mode(s) of operation of the gaming machine 10. The gaming machine 10 includes a touchscreen(s) 24 mounted over the primary or secondary displays 18, 20, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touchscreen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from the group consisting essentially of an electrical current, an electrical voltage, an electrical charge, an optical signal, an optical element, a magnetic signal, and a magnetic element.

The gaming machine 10 includes one or more value input/payment devices and value output/payout devices. The value input devices are used to deposit cash or credits onto the gaming machine 10. The cash or credits are reflected in a credit balance having a corresponding monetary value and are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer. When the gaming machine determines a winning outcome for the wagering game, the credit balance may be modified to reflect the payout for the winning outcome.

Thus, one or more input devices are configured to detect a physical item associated with a monetary value. The detection of the physical item establishes a credit balance that corresponds to a monetary value associated with the physical item. The credit balance changes based on play of the casino wagering game, for example, decreasing when wagers are placed to initiate the wagering game and increased in response to winning outcome(s) of the wagering game. One or more input devices may receive a cashout input (e.g., from the player) that initiates a payout from the credit balance.

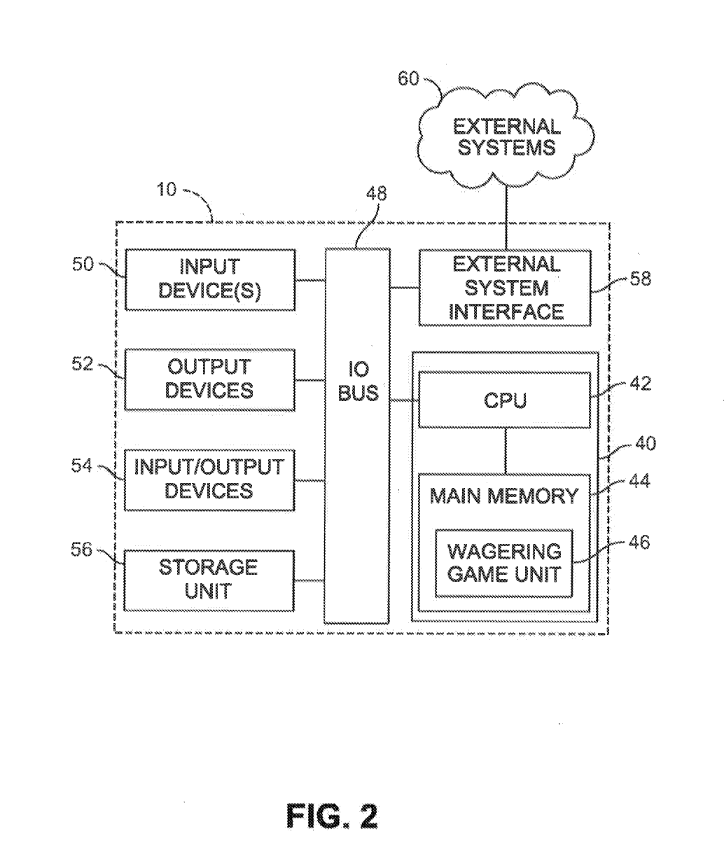

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel Corporation, Santa Clara, Calif. and Advanced Micro Devices, Inc., Sunnyvale, Calif. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices, which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ front side bus and a PCI back side bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., BLUETOOTH®, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

In response to an initiation of a wagering game, an instance of the wagering game is executed and performed until completion. When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in the Nevada Gaming Control Board's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read-only memory (ROM), random access memory (RAM), magnetic-disk storage media, optical storage media, Flash memory, etc.

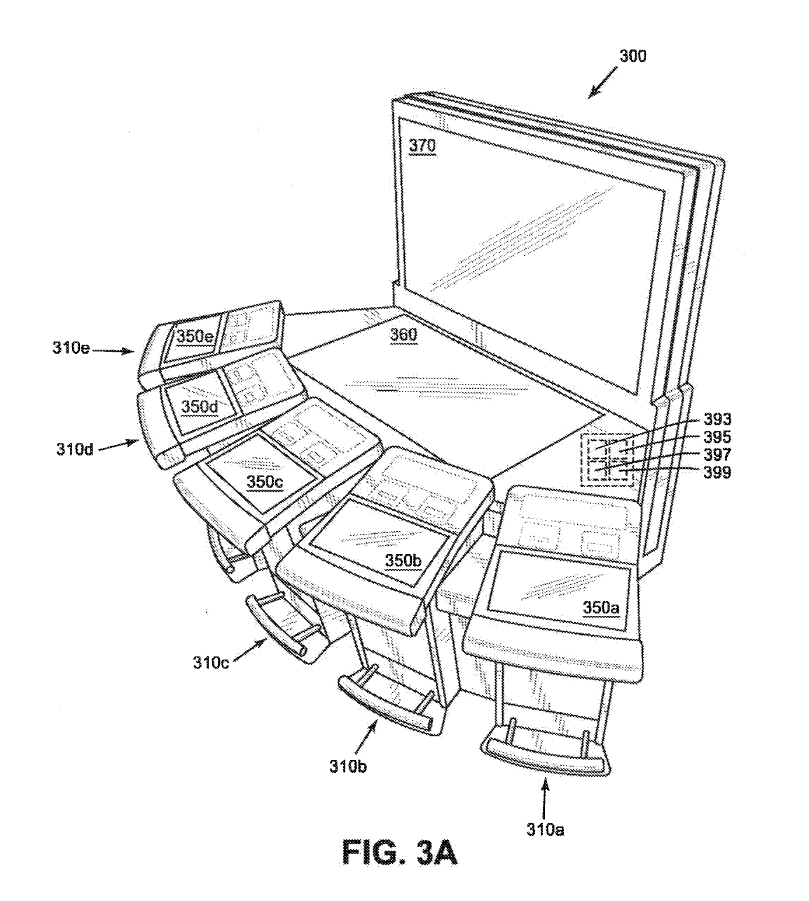

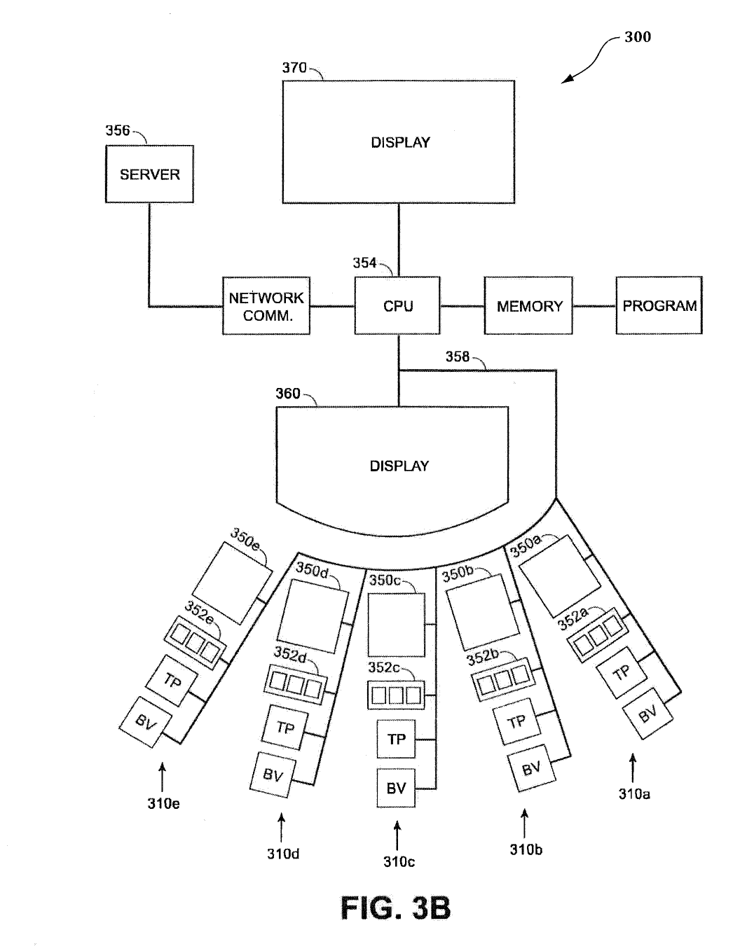

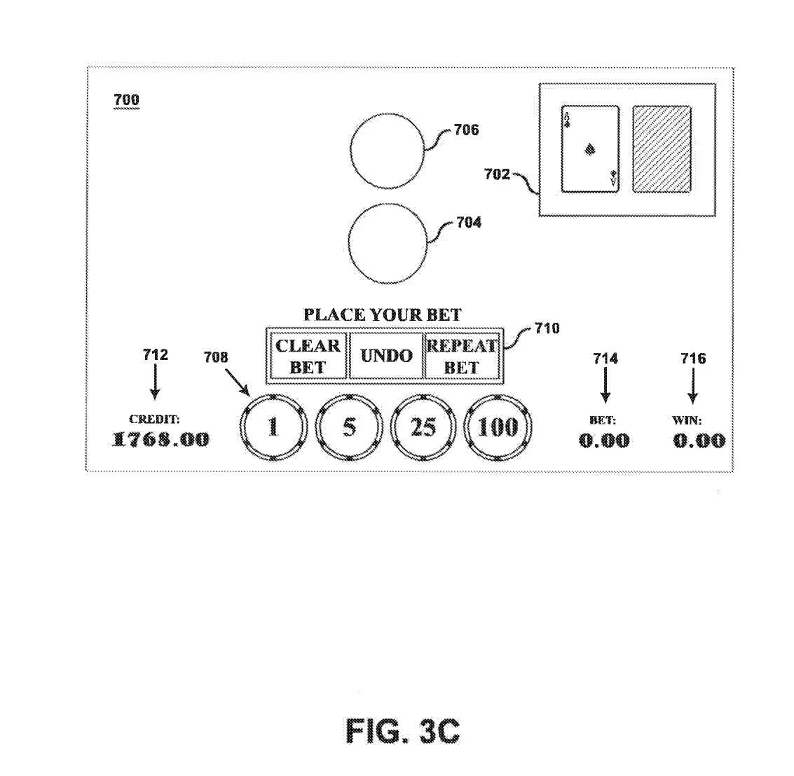

FIG. 3A shows an exemplary multi-player gaming system 300 that can be used to practice the wagering game embodiments of the invention. The multi-player gaming system 300 may include any/all devices and components described above with respect to the gaming machine 10 shown in FIG. 1. Further, the multi-player gaming system 300 may include electronic component and game-logic circuitry architectural features such as those described above with regard to the gaming machine 10.

The gaming system 300 may include a plurality of player stations 310a-310e positioned proximal to a community table display 360. The community table display 360 may be configured to present a “table” surface including representations of player positions and wager locations at each player position. The player stations 310a-310e may also display representations of a table surface with a layout of wager locations that display respective wager amounts and card locations for displaying cards dealt to the player in the course of the wagering game. Embodiments of the invention may further include an upright “dealer” display 370 for displaying a representation of a virtual dealer who “deals” the cards and interacts with players in other ways. Any of the aforementioned displays may comprise a separately partitioned portion of a single display screen and may comprise an individual electronic display device. For purposes of this disclosure, the term “virtual” means a graphical video representation of an object or person, such as a dealer, cards and chips, for example.

As used here and throughout, the terms “display” and “display device” may be used interchangeably to refer to a separately partitioned portion of a display screen and to an individual electronic display device.

The gaming system 300 may also include internal components 393-399 that perform specific, specialized gaming functions. For example, the gaming system 300 may utilize one or more ports 393 for electrically coupling the various components of the community table display 360, for example, displays, input devices, lighting units, audio speakers, etc. Additionally, one or more memories 395 for storing digital information and one or more processors 397 for performing digital logical operations may be integrated into the gaming system 300. One or more communication modules 399 may be used for communicating with local and/or remote computing devices (not shown). The gaming system 300 may further include additional decorative lights and speakers (not shown), which may be located on one or more sides or underside surfaces of the gaming system 300, for example, aligned with the player positions 310a-310e.

Player stations 310a-310e may be arranged in a bank around the table display 360 and an upright display 370, and both the table display 360 and the upright display 370 may be “community” displays that are visible to all players at player stations 310a-310e. The upright display 370 may display a video simulation of the dealer (i.e., a “virtual” dealer) through processing one or more stored programs stored in memory 395 to implement the rules of game play at the table display 360. The table display 360 may be configured to display at least one or more of the dealer's cards, any community cards, and player's cards. Each of the player stations 310a-310e may include a player display 350a-350e configured for wagering and game play interactions with the table display 360 and the upright display 370.

FIG. 3B is a functional schematic drawing of an exemplary multi-player gaming system, such as the gaming system 300. FIG. 3B shows communication paths and connections 358 between the various components of the gaming system. A table display 360 is shown with five adjacent individual player stations 310a-310e. The player stations 310a-310e may comprise separate player displays. In this example, each player station 310a-310e is associated with a player display 350a-350e. Player displays 350a-350e may comprise separate player display portions of an extended table display device or separate player display devices. Each player display 350a-3503 may include player input devices 352a-352e, such as touchscreen input regions and/or discrete input buttons, corresponding to the particular player display. Additional input devices configured to detect physical items associated with monetary value (e.g., TITO tickets, player cards, currency, etc.) may be included at each player station 310a-310e. In FIG. 3B, each player position includes a ticket printer (TP) and a bill validator (BV) configured to detect the physical items and, in the case of the ticket printer, to output physical items associated with a player's credit balance at cashout.

A CPU (including one or more processors) executes instructions of a gaming program stored on one or more memory devices. In FIG. 3B, a central processing unit (CPU) 354 is shown connected for communication to a server 356, and may transmit game data and system data to the server 356. Alternatively, the CPU 354 and one or more memory devices may be resident on a server and operate the multi-player gaming system 300 as a thin or thick client. A local or distributed processing schema as described in previous paragraphs may be utilized in a multi-player gaming system.

Further details of an example of a table and player display are disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface may be a unitary electronic display that is logically partitioned to permit game play from a plurality of players and to receive inputs from, and displaying game information to, the players, the dealer, or both.

In an embodiment, the base game as played on the multi-player gaming system 300 may be a conventional or modified blackjack card game. The processor(s) 397 or other processors of the multi-player gaming system 300 may direct the displays at each player station as well as a community table display to display a gaming surface that is visible to players at all the player stations.

FIG. 3C shows an exemplary game play layout that may be displayed on a player display to facilitate play of a wagering game according to an embodiment of the invention. The layout 700 provides visual cues and input options for a player at a player station, and alternatively may be displayed on a table display. The layout 700 includes a player card area 702 on which the representations of cards dealt to the player are displayed. Also displayed are designated regions for the play wager 704 and the optional bonus wager 706, and bet denomination selections 708 used to formulate wager amounts. In an embodiment, the bet denomination selections 708 are touchscreen regions that can be selected and placed in the play and bonus wager regions, such as via a “drop and drag” process or through various other selection methods. In an embodiment, selectable buttons 710 may be provided to facilitate the betting process. Additionally, meters that inform the player of credit balance 712, current wager amount 714, and current award value 716, may be provided.

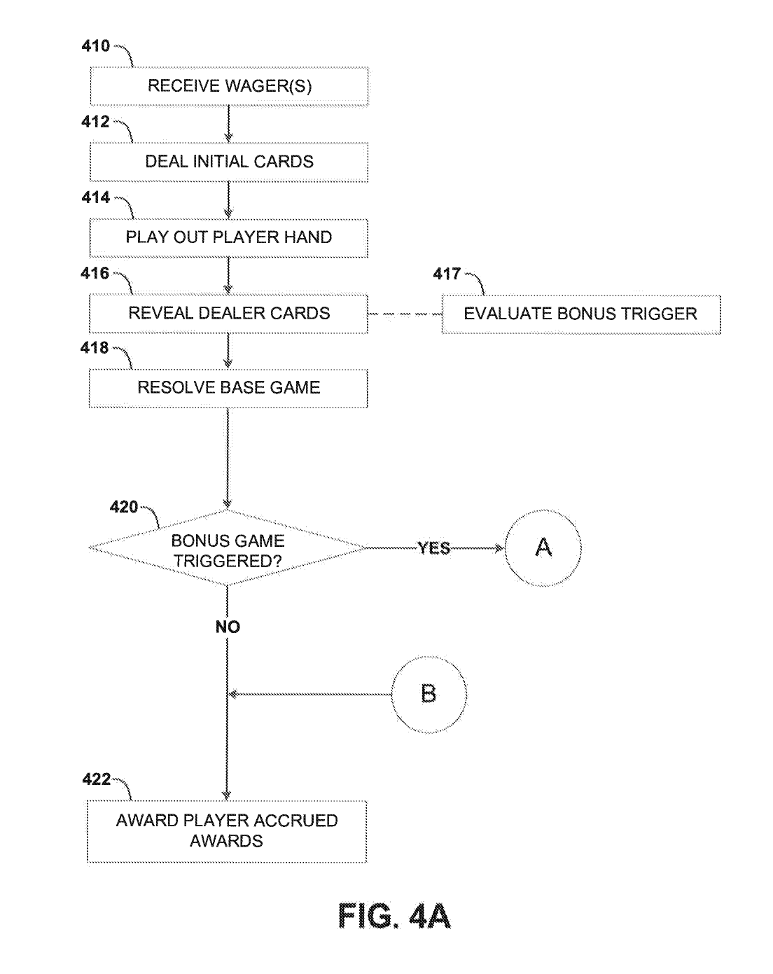

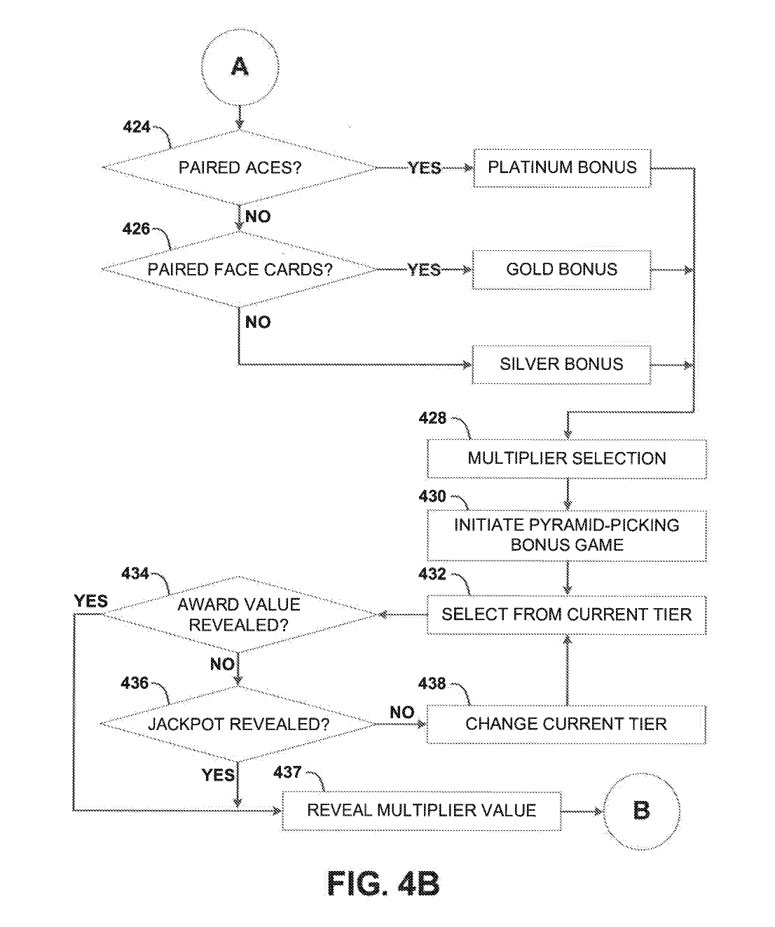

FIGS. 4A and 4B are flowcharts that track game play of an exemplary embodiment of the invention. To play an embodiment of the invention, a player takes a position at one of the player stations. A credit balance for the player is established on the gaming system via a player input device that detects a physical item (e.g., ticket, credit/debit card, player account card, currency, etc.) associated with a monetary value. The credit balance may be displayed on a credit meter or other visual indicia.

The gaming system receives 410 at least one wager input indicating a base-game wager, including a base wager amount covered by the credit balance, to initiate a play of the wagering game. At the same time, the player may opt to place the optional bonus-game wager to participate in the bonus game. Either wager input may be in the form of pressing a particular button at the player station, or an input to a touchscreen region of the player display, or via various other input methods and apparatus. The base-game wager and the bonus-game wager may be displayed on the player display in a designated base wager position and a designated bonus wager position, as directed by the one or more processors.

Upon receipt of the wager(s), the one or more processors select two initial cards of a blackjack hand for the player hand and “deal” 412 the cards by directing the player station to display a visual representation of the player's hand in the player's card position. The gaming system may also display the player's hand in the player's position on the table display. Each participating player is dealt a corresponding two-card initial hand at their respective station. The one or more processors further select and deal a two-card initial dealer hand and display the dealer hand (face down) in the dealer card position on the table display. The players are permitted to inspect their respective hands.

The base game continues with each player sequentially playing 414 for the best possible blackjack hand to be compared to the final dealer hand. That is, each player accepts additional cards as desired to achieve a hand with a total face value of twenty-one or less. If an additional card causes the player's hand to exceed twenty-one, the player has “busted” and their base-game wager is swept. When the participating players have all played their hands, the dealer reveals 416 the two initial dealer cards.

The two initial dealer cards determine whether the bonus game is triggered for the current play, and the criteria for triggering is evaluated 417. Specifically, if the two initial dealer cards match each other in rank and color, the bonus game is triggered 420 and will be conducted after the base game is resolved. Further, the particular rank of the matching dealer cards may determine a bonus level at which the bonus game is played. Further details of the triggering condition and the bonus level determination will be discussed in detail later in this paper. After the initial dealer cards are revealed and evaluated for the bonus trigger, the base game proceeds according to the rules of the appropriate blackjack game.

After revealing the two initial dealer cards, the dealer hand is completed by either staying with the initial cards or by dealing, via the one or more processors, additional cards to attain a total face value of twenty-one or less. If an additional card causes the dealer hand to exceed twenty-one, the dealer has busted and the active players (i.e., those players who did not bust themselves) are awarded according to their respective wagers and the pay table of the wagering game. If the dealer does not bust, the base game is resolved 418 according to the blackjack rules and players are awarded 422 any base game awards based on their respective blackjack hands.

After the base game is resolved and when there is at least one player eligible to participate in the bonus game, the one or more processors conduct the bonus game for each eligible player on their respective player station, the table display, or both. In some embodiments, each player's individual bonus game is played separately and sequentially and some players may be idle during play of another player's bonus game.

FIG. 4B depicts steps of an exemplary bonus game. If the bonus game is triggered (by the two initial dealer cards) and at least one player has placed a bonus-game wager, the bonus game may be conducted after the base game is resolved. In some embodiments, any player who places a bonus-game wager in a play of the wagering game can participate in the subsequent bonus game. In other embodiments, a player who places a bonus wager must also win the base game in order to play the bonus game. In still other embodiments, a player must win or push the base game to play the bonus game.

As discussed previously, the two initial dealer cards determine whether the bonus game is triggered for play after the base game. To trigger the bonus game, the initial dealer cards must match in rank (i.e., A-K-Q-J-10-9-8-7 . . . etc.) and also in suit color (e.g., Clubs and Spades are black, Hearts and Diamonds are red). For example, a dealer hand of 9-CL and 9-SP are both 9s and both black suits—therefore, the bonus game is triggered. Conversely, a dealer hand of 9-CL and 9-DI (different colors) or 9-CL and 5-SP (different ranks) will not trigger the bonus game.

In addition, the rank of the matching dealer cards may determine at which of a plurality of bonus levels the bonus game will be conducted. For example, in an embodiment having a low, medium, and high bonus level, matching Aces 424 may trigger the high level, matching cards of rank J-K (face cards) may trigger 426 the medium level, and matching cards of rank 2-10 may trigger the bonus game at the low bonus level. In one embodiment, the levels are designated Silver, Gold, and Platinum. Various ranking schemes may correspond to different bonus levels, and the number of bonus levels may vary. So, for example, while the exemplary bonus game embodiment has three levels (high-medium-low), other embodiments may also include more than three or fewer than three bonus levels.

Typically, different bonus levels provide opportunities for different award values and may include higher or lower probabilities of achieving awards. Parenthetically, different wager amounts may also affect the award values and/or probabilities of achieving awards for the respective player.

The bonus game may include a multiplier selection 428. A multiplier is associated with a player and may be applied to awards achieved during the bonus game. Typically, the multiplier is a number that multiplies some or all award values in the bonus game to provide opportunities for increased awards, although other types of multipliers may be applied in various ways.

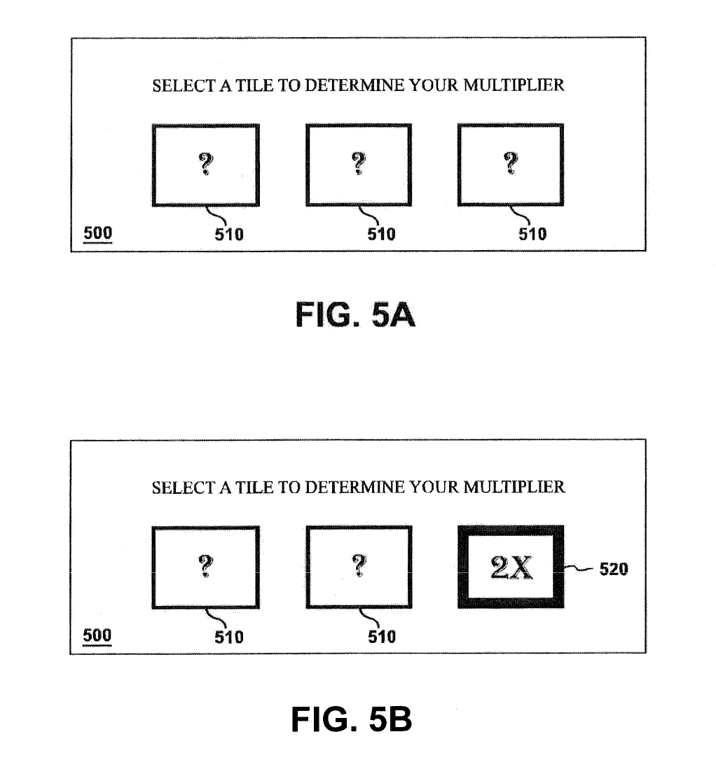

In an embodiment, the multiplier selection 428 comprises a player picking process as illustrated in FIGS. 5A-5B. As shown in FIG. 5A, a display presentation 500 is displayed on a display so that the player can conduct the multiplier selection process. The display presentation 500 includes a set of selectable multiplier indicia 510 having hidden associated multiplier values. Initially, the multiplier indicia 510 actively conceal the corresponding multiplier values, making the player selection essentially a random selection. As shown in the embodiment of FIG. 5B, the multiplier indicia on the right has been selected and reveals the associated 2X multiplier value 520. In the embodiment illustrated by the flowchart of FIG. 4B, the selected multiplier amount is not revealed 437 until the bonus awards are tabulated at the end of the bonus game. In other embodiments, the selected multiplier value 520 may be shown after a bonus award is determined, or may never be shown. In an embodiment, the unselected multiplier values are revealed to the player after multiplier selection is complete.

Multiplier values may vary for various bonus games and bonus levels. In an embodiment, a higher bonus game level may have higher multiplier values available for selection. In another embodiment, there may be a fixed set of multiplier values that are constant among bonus games. Other embodiments may include variable multipliers that are randomly determined or scaled with the player current wager.

The selectable multiplier indicia 510 may be of any graphical type and may be coordinated thematically with the base wagering game and/or the casino and surroundings. For example, the three selectable multiplier indicia 510 may depict three different women: a blonde-haired woman, a brown-haired woman, and a red-haired woman. Likewise, any type of thematic graphical imagery may be implemented to customize the presentation of the multiplier selection.

Returning to FIG. 4B, the bonus game process continues by initiating 430 play of the bonus game after selecting a multiplier. The bonus game may be any of various bonus games and need not be, similar or related to the base blackjack game. In an embodiment, the bonus game is a “pyramid” picking bonus. In the pyramid-picking bonus, the one or more processors cause a display of a pyramid of tiers of diminishing numbers of selectable boxes—the bottom tier having the most indicia and the number of indicia per tier decreasing with each higher tier. Each box may be associated with various award values or with an “UP” symbol that advances the player to next-higher tier.

To play the pyramid bonus game, a player begins by making a selection 432 from the bottom tier which is the “current tier” at the start of the pyramid bonus game. The selection may be received by the one or more processors from an input device as previously described. Upon selecting an indicia, an award value associated with the indicia is revealed 434 to the player, or, if the selected indicia advances the player to the next tier, an UP arrow or some other suitable symbol or text is revealed. In the latter case, the player may be enabled to make a selection 438 from the next-higher tier. As long the player selects consecutive advancing indicia, they may continue selecting from next-higher tiers until reaching the top tier. The top tier of the pyramid includes an indicia associated with a jackpot award that may be awarded 436 upon selection by the player. In the former case, when the selected indicia reveals an award amount, the award amount is multiplied by the multiplier and the result is awarded to the player. The player then receives “B” the accrued awards from both the base game and the bonus game. In some embodiments, the jackpot award is also multiplied by the selected multiplier. In other embodiments, the multiplier is not applied to the jackpot award. Award amounts may be added to the credit balance associated with the player and may be indicated on the credit and current award meters.

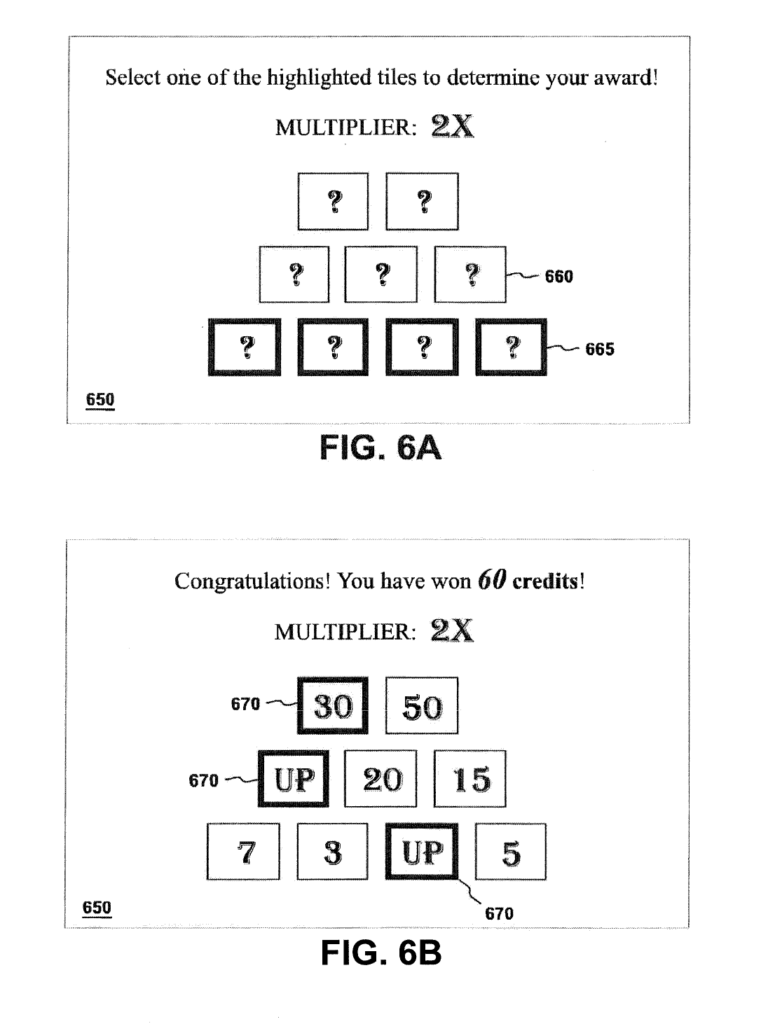

A pyramid-picking bonus as described above is illustrated in FIGS. 6A and 6B. FIG. 6A shows an exemplary game screen 650 that may be displayed on a table display and/or on a player display. Screen 650 includes a pyramid of selectable tiles 660 arranged in tiers of diminishing number. The bottom tier 665 is shown highlighted to direct the player to make a selection from the bottom tier. For this pyramid bonus game, the selected multiplier is shown to be 2×. However, the multiplier value for a bonus game may or may not be revealed during play of the bonus game

FIG. 6B shows the exemplary game screen 650 after the player has made successive selections on each tier. In this embodiment, the values of all the unselected tiles are displayed with the values of the selected tiles. A first selection 670 from the bottom tier reveals an UP symbol that promotes the player to the middle tier. A second selection 670 from the middle tier reveals another UP symbol that promotes the player to the top tier, which includes the jackpot award of 50 credits. Unfortunately for the player, the third selection 670 reveals the 30 credit award instead of the 50 credit jackpot. Based on the three picks, the player has earned an award of 30 credits which is multiplied by the 2× multiplier for a total award of 60 credits. In an embodiment, the 60 credits are added to any awards accrued in the base game, and the total is added to the credit balance associated with the player.

In some embodiments, the jackpot award may be a progressive jackpot award. The progressive jackpot may be funded, at least in part, by “coin-in” at the multi-player gaming system or by coin-in from a plurality of gaming machines connected over a network. The network may be local and may be distributed across multiple properties, even across multiple jurisdictions and states.

In an embodiment, the number of tiers in the pyramid bonus game may vary according to the bonus level at which the bonus game is being conducted. For example, a pyramid in a Silver (or low) level bonus game may comprise three tiers with 4/3/2 indicia per respective tier. The Gold (or medium) level bonus game may comprise four tiers with 5/4/3/2 indicia, respectively, and the Platinum (or high) level bonus game may comprise five tiers with 6/5/4/3/2 indicia. Other combinations and configurations of tiers and indicia are envisioned and are considered within the scope of the invention. The number of tiers, and the number of indicia available for selection in each tier, may be directly related to the probability of winning a particular award in the bonus game.

An embodiment of the invention may be presented on a standalone gaming machine such as that shown in FIG. 1, or in a bank of standalone gaming machines connected for communication. A bank of gaming machines may include a community display that is visible from each gaming machine in the bank. Game elements and images are presented on the primary display device 18 and/or the secondary display device 20 and are configured sensibly in relation to the player's position as well as the placement of player input devices. For example, the virtual dealer may be displayed on the secondary display device 20 and the player and dealer card areas may be displayed on the primary display device 18. Depending on the equipment configuration of the gaming machine, player inputs may be received at the touchscreen 24 or the buttons 26.

For a standalone gaming machine, the player may play against a virtual dealer (i.e., the one or more processors) similarly to play on the multi-player gaming system. The flowcharts of FIGS. 4A and 4B may apply equally to the wagering game presented on a standalone gaming machine, with the acknowledgment that there is only a single player. Triggering the bonus game may depend on the two initial dealer cards, and triggering criteria may be similar to that of the multi-player gaming system. Similarly, the bonus game may be conducted in the same manner on both multi-player and standalone gaming apparatus.

An embodiment of the invention may be conducted online over a communication network, such as the Internet. The CPU and memory devices that execute and store the game instructions may be resident on a remote server. Similar to the thick/thin client configurations, random selections of game outcomes may be produced by a remote RNG and transmitted to the designated player station(s), which may include a PC, a cellphone, a PDA, and various other remote and/or mobile devices.

1.-20. (canceled)

21. A multi-player gaming system comprising:
a plurality of player terminals, each player terminal of the plurality of player terminals including a terminal video display, a player input interface, and an acceptor for receiving monetary value to establish credits for wagering;
a community video display positioned to be viewable by players at the plurality of player terminals;
a processor in communication with the community video display and each player terminal of the plurality of player terminals, the processor configured to:
receive, from each player input interface of at least two player terminals of the plurality of player terminals, player input indicating a player's base game wager of credits and a separate bonus wager of credits,
control the community and terminal video displays to display data representing an initial set of playing cards for a first hand and an initial set of playing cards for a competing second hand according to predetermined rules of a base card game, the playing cards randomly selected from an inventory of playing cards;
control the community and terminal video displays to display data representing at least one additional playing card, if any, distributed to complete the first and second hands, to compare the completed first and second hands according to the predetermined rules of the base game to define for each player a base game winning or losing outcome and to issue an award for a base game winning outcome based upon the player's base game wager; and
compare the initial set of playing cards for the first hand to a predetermined bonus game trigger condition and if the trigger condition is satisfied, control each player terminal of the at least two player terminals from which the player input indicating the separate bonus wager has been received to conduct a separate, individual bonus game at each terminal video display to produce either bonus game winning or losing outcome for each player and to issue an award for a bonus game winning outcome based upon the bonus wager.

22. The multi-player gaming system of claim 21, wherein the acceptor for receiving monetary value to establish credits for wagering comprises a value input device configured to accept cash or credits.

23. The multi-player gaming system of claim 21, wherein the processor being configured to control the community and terminal video displays to display data representing an initial set of playing cards for a first hand and an initial set of playing cards for a competing second hand according to predetermined rules of a base card game comprises the processor being configured to control the community and terminal video displays to display data representing an initial set of playing cards for a first hand and an initial set of playing cards for a competing second hand according to predetermined rules of a base blackjack game or a base baccarat game.

24. The multi-player gaming system of claim 21, wherein the processor being configured to control the community and terminal video displays to display data representing an initial set of playing cards for a first hand and an initial set of playing cards for a competing second hand comprises the processor being configured to control the community and terminal video displays to display data representing an initial set of two playing cards for a first hand and an initial set of two playing cards for a competing second hand.

25. The multi-player gaming system of claim 24, wherein the predetermined bonus game trigger condition comprises the two cards of the initial set of playing cards for the first hand having the same rank and the same color.

26. The multi-player gaming system of claim 21, wherein the first hand is a dealer hand.

27. The multi-player gaming system of claim 26, wherein the processor is further configured to:
determine a bonus level of the bonus game based on a rank of the initial set of playing cards for the dealer hand; and
determine a number of current-tier indicia corresponding to a bonus outcome and a number of next-tier indicia corresponding to a bonus outcome, the number of the current-tier indicia and the number of the next-tier indicia being based on the determined bonus level.

28. The multi-player gaming system of claim 27, wherein the processor is further configured to:
control the terminal video displays to display a plurality of selectable multiplier indicia, the number of selectable multiplier indicia based on the bonus level, each multiplier indicia corresponding to a respective bonus award multiplier;
receive an input indicative of a selected multiplier indicium; and
increase the bonus game award amount using the bonus award multiplier corresponding to the selected multiplier indicium.

29. The multi-player gaming system of claim 28, wherein the processor is further configured to control the community video display and the terminal video display to display the bonus award multiplier corresponding to the selected multiplier indicium.

30. The multi-player gaming system of claim 27, wherein the bonus level of the bonus game is determined from a set of three bonus levels, and wherein the number of current-tier indicia, the number of next-tier indicia, and the number of selectable multiplier indicia are different for each bonus level of the set of three bonus levels.

31. The multi-player gaming system of claim 30, wherein, at a highest bonus level of the set of three bonus levels, the number of current-tier indicia is six and the number of selectable multiplier indicia is four.

32. The multi-player gaming system of claim 30, wherein, at a highest bonus level of the set of three bonus levels, the current-tier indicia includes an award of a progressive jackpot award.

33. The multi-player gaming system of claim 21, further comprising a dealer video display, wherein the processor is further configured to control the dealer video display to display a virtual representation of a dealer.

34. The multi-player gaming system of claim 21, wherein the plurality of player terminals comprises five player terminals.

35. A multi-player gaming system, comprising:
at least two player stations for use by at least two respective players, each player station comprising a player display and a player input device;
at least one community display positioned to be viewable by the at least two respective players at the at least two player stations;
at least one processor operably connected to the at least two player stations and to the at least one community display, the at least one processor being configured to receive inputs from the player input devices of the at least two player stations, the at least one processor being further configured to:
receive a bonus wager from the at least two player stations;
determine at least a first player set of playing cards a second player set of playing cards of a base game;
cause the at least two player stations to respectively display the first player set of playing cards and the second player set of playing cards for review by the at least two respective players;
determine a base game winning outcome or losing outcome for each of the at least two respective players based on the respective first player set of playing cards and second player set of playing cards; and
in response to a predetermined bonus game trigger condition being met, control the at least two player stations from which the bonus wagers are received to conduct a separate, individual bonus game to result in either a bonus game winning outcome or a bonus game losing outcome for the at least two respective players.

36. The multi-player gaming system of claim 35, wherein the at least one processor is further configured to determine a dealer set of playing cards, wherein the predetermined bonus game trigger condition comprises the dealer set of playing cards having a same rank and a same color.

37. The multi-player gaming system of claim 35, wherein the predetermined bonus game trigger condition comprises the first player set of playing cards having a same rank and a same color.

38. The multi-player gaming system of claim 35, wherein conducting the separate, individual bonus game comprises displaying at the at least two player stations a set of selectable indicia having hidden associated credit values or multiplier values for selection by the at least two respective players.

39. A method of administering a wagering game on a multi-player gaming system including a community display, a plurality of player stations including respective player displays, and at least one processor operatively coupled to the community display and to the plurality of player stations, the method including:
receiving, from at least one player station of the plurality of player stations, a player input from an active player indicative of a base game wager and another player input from the active player indicative of a bonus wager;
directing, by the at least one processor, the at least one player display of the at least one player station to display an initial set of player cards;
resolving, by the at least one processor, a base game based on at least the initial set of player cards to determine a base game award amount;
in response to another initial set of cards having at least a same rank, triggering and conducting a bonus game at a bonus level corresponding to the rank of the another initial set of cards, conducting the bonus game comprising:
directing, by the at least one processor, the at least one player display of the at least one player station to display a plurality of selectable current-tier indicia and a plurality of selectable next-tier indicia, a number of the current-tier indicia being greater than a number of the next-tier indicia, each of the current-tier indicia corresponding to a bonus outcome determined at least in part by a random number generator;
receiving, from the at least one player station of the plurality of player stations, a player bonus input from the active player indicative of a selected current-tier indicium;
in response to the selected current-tier indicium corresponding to a tier-advancement bonus outcome, designating, by the at least one processor, the next-tier indicia available for selection; and
in response to the selected current-tier indicium corresponding to a bonus outcome indicating an award amount, determining, by the at least one processor, a corresponding bonus game award amount; and
granting, by the at least one processor and to the active player, a total award amount corresponding to the base game award amount and the bonus game award amount.

40. The method of administering a wagering game on a multi-player gaming system of claim 39, further comprising directing, by the at least one processor, the at least one player display and the community display to display the determined bonus game award amount.
